(19) United States
(12) Patent Application Publication
(10) Pub. No.: US 2003/0083881 A1
(43) Pub. Date: May 1, 2003

(54) Voice input module that stores personal data

(76) Inventor: Shu-Ming Liu, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 09/683,975

(22) Filed: Mar. 7, 2002

(30) Foreign Application Priority Data
Nov. 1, 2001 (TW) 090127198

(51) Int. Cl. G10L 21/00

(52) U.S. Cl. 704/270.1; 704/275

(57) ABSTRACT

A portable voice input module that can store data. The voice input module stores personal data relevant to the user. The voice input module can connect to a computer. The computer runs a language processing program that can translate voice signals spoken by the user into computer commands. The computer accesses the personal data stored in the memory of the voice input module to execute the computer commands. The language processing program can automatically update its files and databases by connecting to a server using the internet. The language processing program can also translate computerized documents, such as e-mail, into voice signals and send the voice signals to the voice input device for playback.

### BACKGROUND OF INVENTION

1. Field of the Invention

The present invention relates to a portable voice input module, and more particularly, to a voice input module that stores personal data.

2. Description of the Prior Art

In modern society, computer systems are no longer viewed as costly toys reserved for the wealthy, but as necessities for ordinary people in their daily lives. Sometimes, it is not convenient for people to use hands to input computer commands. A language processing program for translating human voices into computer input can facilitate the input operation.

Please refer to FIG. 1 and FIG. 2. FIG. 1 is a schematic diagram of a prior art voice input module 20, and FIG. 2 is a function block diagram of the voice input module 20. The voice input module 20, such as a microphone, is connected to a computer system 10. The computer system 10 has a language processing program 12 for translating voice signals input by the microphone 20 into corresponding computer commands. For example, a user can use the microphone 20 to command the computer system 10 to open an application program, input data from the microphone 20, store files, or close an application program. However, using the microphone 20 to input voice data has its disadvantages. When the user wants to deliver a frequently using command, he has to use the microphone 20 to input the same voice data each time when he wants to use the computer system 10. For example, the user has to use the microphone 20 to input an e-mail account, a user name and a password each time when he uses the microphone 20 to deliver a command to the computer system 10 to read his e-mail, which is highly inefficient.

### SUMMARY OF INVENTION

It is an objective of the claimed invention to provide a voice input module capable of storing personal data to solve the above-mentioned problem.

According to the claimed invention, a portable voice input module capable of connecting to a computer system is provided. The computer system has a language processing program for translating voice signals input by the voice input module into corresponding computer commands. The voice input module has a microphone for processing voice signals spoken by a user and a memory for storing personal data used by the user. When the voice input module connects to the computer system, the computer system is capable of retrieving the personal data stored in the memory. When the language processing program of the computer system translates the voice signals input by the voice input module into the corresponding computer commands, the computer system executes the computer commands and utilizes the personal data stored in the memory of the voice input module to complete the computer commands.

It is an advantage of the present invention that the voice input module can store personal data and frequently using data in the memory of the voice input module to save operation time.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a voice input module according to the prior art.

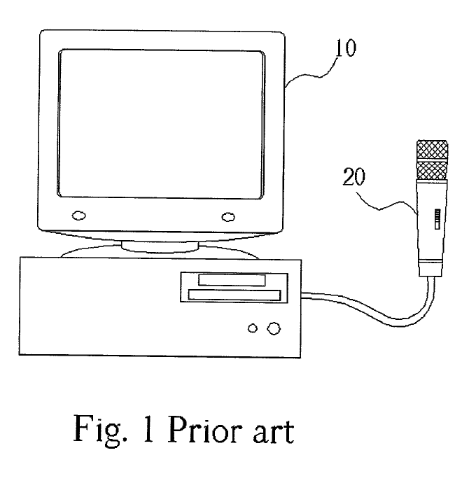

FIG. 2 is a function block diagram of the voice input module according to the prior art.

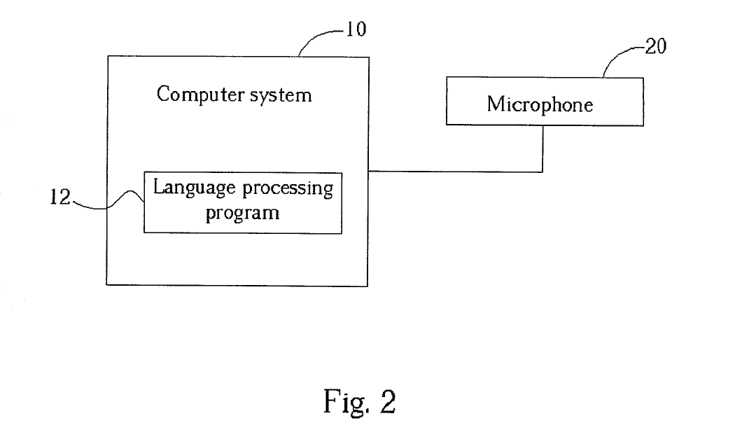

FIG. 3 is a schematic diagram of a voice input module according to the present invention.

FIG. 4 is a function block diagram of the voice input module according to the present invention.

### DETAILED DESCRIPTION

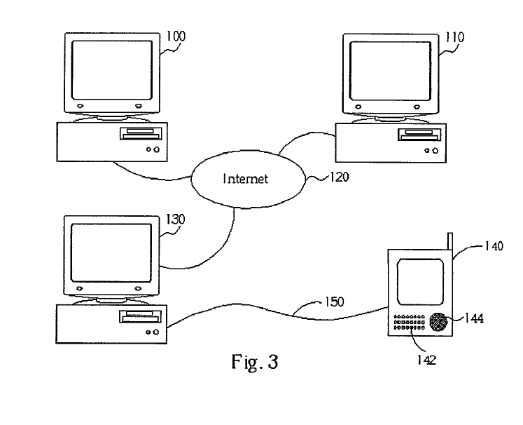

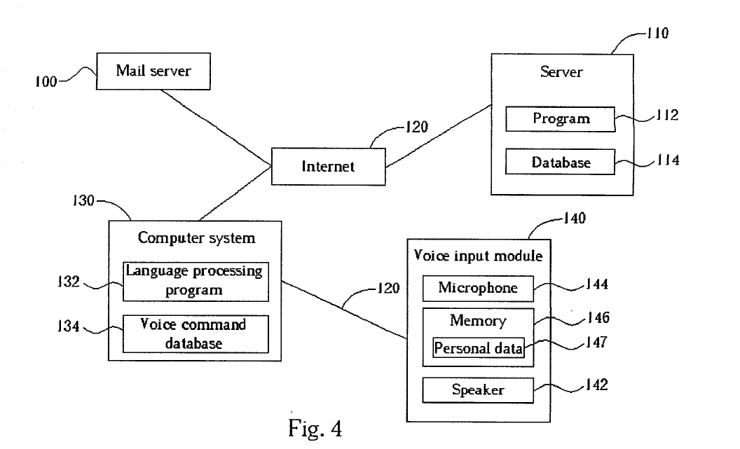

Please refer to FIG. 3 and FIG. 4. FIG. 3 is a schematic diagram of a voice input module 140 of the present invention, and FIG. 4 is a function block diagram of the voice input module 140. The voice input module 140 is portable and can be connected to a computer system 130. The computer-system 130 has a language processing program 132 for translating voice signals input by the voice input module 140 into corresponding computer commands. The voice input module 140 has a microphone 144 for processing voice signals spoken by a user and a memory 146 for storing personal data 147 used by the user.

As shown in FIG. 3 and FIG. 4, when the voice input module 140 is connected to the computer system 130, the computer system 130 can retrieve the personal data 147 stored in the memory 146. In addition, when the language processing program 132 of the computer system 130 translates the voice signals input from the voice input module 140 into the corresponding computer commands, the computer system 130 executes the computer commands and utilizes the personal data 147 stored in the memory 146 of the voice input module 140 to complete the computer commands.

In the preferred embodiment, the voice input module 140 is a personal data assistant (PDA). Alternatively, the voice input module 140 can be a mobile phone or other device having similar functionality. The voice input module 140 is connected to the computer system 130 either by a wire connection 150 or by a wireless connection. In the preferred embodiment of the present invention, the connection between the voice input module 140 and the computer system 130 is by a wire connection 150, such as a universal serial bus (USB) connection or a RS232 connection. Bluetooth communication protocol can be used if the connection between the voice input module 140 and the computer system 130 is by a wireless connection.

In addition, the computer system 130 is connected to an internet 120. When the user uses his PDA 140 to read e-mail and the personal data 147 that is stored in the memory 146 of the PDA 140 includes an e-mail account for the user, the language processing program 132 of the computer system 130 will first identify the voice commands spoken by the user. If the voice commands comprise reading e-mail, the computer system 130 will execute the commands and utilize the e-mail account stored in the memory 146 of the PDA 140 to connect to a mail server 100 using the internet 120 to read the e-mail in the user's e-mail account on the mail server 100. In addition, the PDA 140 includes a speaker 142 for transforming the e-mail into sounds. After the computer system 130 reads the e-mail of the user, the computer system 130 uses the language processing program 132 to transform the e-mail into voice signals, and then uses the speaker 142 of the PDA 140 to output the voice signals to the user.

As shown in FIG. 4, the language processing program 132 of the computer system 130 has a voice command database 134, and the language processing program 132 uses the voice command database 134 to analyze the voice commands input by the PDA 140 and translates the voice commands into corresponding computer commands. In addition, the language processing program 132 or the voice command database 134 of the computer system 130 can use the internet 120 to connect to a server 110 to download a program 112 or a database 114 to update the language processing program 132 or the voice command database 134 from the server 110.

In contrast to the prior art, the voice input module can store personal data and frequently used data in the memory of the voice input module in order to save operation time. In addition, the voice command database of the language processing program of the computer system can download the newest commands from another server to ensure the best and newest analyzing capabilities for the language processing program.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A portable voice input module capable of connecting to a computer system, the computer system comprising a language processing program for translating voice signals inputted from the voice input module into corresponding computer commands, the voice input module comprising:
a microphone for processing voice commands spoken by a user to voice signals; and
a memory for storing personal data used by the user;
wherein when the voice input module connects to the computer system, the computer system is capable of retrieving the personal data stored in the memory, and when the language processing program of the computer system translates the voice signals inputted from the voice input module into the corresponding computer commands, the computer system executes the computer commands and utilizes the personal data stored in the memory of the voice input module to complete the computer commands.

2. The voice input module of claim 1 wherein the computer system is connected to an internet, the voice commands spoken by the user comprise commands to read a mail of the user, the personal data stored in the memory of the voice input module comprise a mail address of the user, and when the language processing program of the computer system identifies that the voice commands spoken by the user comprise commands to read the mail, the computer system executes the commands and utilizes the mail address stored in the memory of the voice input module to complete the computer commands.

3. The voice input module of claim 2 wherein the voice input module further comprises a speaker for transforming the voice signals to sounds, and after the computer system reads the mail of the user, the computer system transforms the mail by the language processing program to voice signals and outputs the voice signals using the speaker of the voice input module to the user.

4. The voice input module of claim 1 wherein the language processing program of the computer system comprises a voice command database, and the language processing program uses the voice command database to analyze the voice commands inputted by the voice input module to translate the voice commands to corresponding computer commands.

5. The voice input module of claim 4 wherein the language processing program or the voice command database is downloaded or updated from an internet web site.

6. The voice input module of claim 1 wherein the voice input module is connected to the computer system by a wire connection or by a wireless connection.

7. The voice input module of claim 6 wherein the wire connection comprises a universal serial bus (USB) connection or an RS232 connection.

8. The voice input module of claim 6 wherein the wireless connection uses a bluetooth communication protocol.

9. The voice input module of claim 6 wherein the voice input module comprises a mobile phone or a personal data assistant (PDA).
